(19) United States
(12) Patent Application Publication
(10) Pub. No.: US 2003/0021378 A1
(43) Pub. Date: Jan. 30, 2003

(54) X-RAY SOURCE BEARING HOUSING ASSEMBLY

(76) Inventors: Daniel John Noonan, Middle Grove, NY (US); Mark Ernest Vermilyea, Niskayuna, NY (US); Antonio Alberto Mogro-Campero, Niskayuna, NY (US); Liangfeng Xu, Irving, TX (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/682,126

(22) Filed: Jul. 25, 2001

(51) Int. Cl. H01J 35/10; H01J 35/24; H01J 35/26; H01J 35/28

(52) U.S. Cl. 378/132; 378/131; 378/144

(57) ABSTRACT

X-ray source bearing assemblies are described herein. In an exemplary embodiment, an x-ray source includes a target anode, a rotor shaft coupled to the target anode, and a motor coupled to the rotor shaft at an end of the shaft opposite the target anode. The bearing housing, in the exemplary embodiment, includes a rotor bore, the rotor shaft extending through said rotor bore and supported therein by a plurality bearings. The housing and the shaft form a cooling medium pool so that as the shaft rotates, a cooling medium in the pool is radially displaced.

### BACKGROUND OF INVENTION

This invention relates generally to x-ray sources, and more particularly to an x-ray source bearing assembly for facilitating heat dissipation.

In medical x-ray imaging, an x-ray source is utilized for generating x-ray beams that pass through an object being imaged. More specifically, an x-ray source projects a fan-shaped beam which is collimated to lie within an X-Y plane of a Cartesian coordinate system and generally referred to as an “imaging plane”. The xbeam passes through an object being imaged, such as a patient. The beam, after being attenuated by the object, impinges upon an array of radiation detectors. The intensity of the attenuated beam radiation received at a detector array is dependent upon the attenuation of the x-ray beam by the object. Each detector element of the array produces a separate electrical signal that is a measurement of the beam attenuation at the detector location. The attenuation measurements from all the detectors are acquired separately to produce a transmission profile.

A typical x-ray source includes an x-ray tube which emits an x-ray beam at a focal spot. Known x-ray tubes include a cathode aligned with a rotating target anode. An electron beam generated at a cathode emitter is directed towards the anode and forms a focal spot on an anode surface. As a result, x-ray beams are emitted from the anode.

The target anode is rotated by a rotor shaft coupled to a motor. Specifically, the rotor shaft extends from the motor, through a bearing housing, to the anode. The shaft is supported by bearings contained in the bearing housing, and rotates relative to the bearing housing.

During operation, the motor rotates, or drives, the rotor shaft to rotate, and the target anode rotates with the shaft. Rotation of the shaft on the bearings results in heat being generated in the bearing housing. The heat generated by the rotating shaft should be dissipated in order to avoid failure of the x-ray tube bearings.

### SUMMARY OF INVENTION

In one aspect, an x-ray source including a cooling medium pool for cooling rotor shaft bearings is provided. In an exemplary embodiment, the x-ray source includes a target anode, a rotor shaft coupled to the target anode, and a motor coupled to the rotor shaft at an end of the shaft opposite the target anode. The source further includes a bearing housing including a rotor bore. The rotor shaft extends through the rotor bore and is supported therein by a plurality bearings. The housing and the shaft form a cooling medium pool so that as the shaft rotates, a cooling medium in the pool is radially displaced.

In another aspect, a method for assembling a rotor shaft and a bearing housing is provided. The bearing housing has a rotor bore therethough and includes a first section and a section. The method includes the steps of locating the first bearing housing section so that the rotor shaft extends therethrough and so that an outer race of the first bearing housing section aligns with an inner race of the rotor shaft, and locating the second bearing housing section so that the rotor shaft extends therethrough and so that an end section of the second section mates with the first section, and welding the first section to the second section.

In yet another aspect, a bearing housing and rotor assembly is provided. The assembly includes a rotor shaft, and a bearing housing. The bearing housing includes a rotor bore, and the rotor shaft extends through the rotor bore and is supported therein by a plurality bearings. The housing and the shaft form a cooling medium pool so that as the shaft rotates, a cooling medium in the pool is radially displaced.

### BRIEF DESCRIPTION OF DRAWINGS

FIG. 1 is a schematic illustration of an x-ray tube;

FIG. 2 is a cross-sectional side view of a portion of a bearing housing;

FIG. 3 is a side view of a rotor shaft;

FIG. 4 is a front view of a rotor collar; and

FIG. 5 is a side view of the rotor collar shown in FIG. 4.

### DETAILED DESCRIPTION

Although specific embodiments of a bearing housing and rotor assembly, sometimes referred to herein as a bearing housing assembly, are described herein in the context of an exemplary x-ray source, such assembly is not limited to practice with such exemplary x-ray source and can be utilized in connection with other x-ray sources. In addition, the exemplary x-ray source is sometimes described in the context of a computed tomography (CT) machine, and more specifically, a third generation CT machine. The bearing housing and rotor assembly can, however, be utilized in connection with other types of x-ray machines. Therefore, the description of the bearing housing and rotor assembly in connection with an x-ray source for a CT machine is exemplary only.

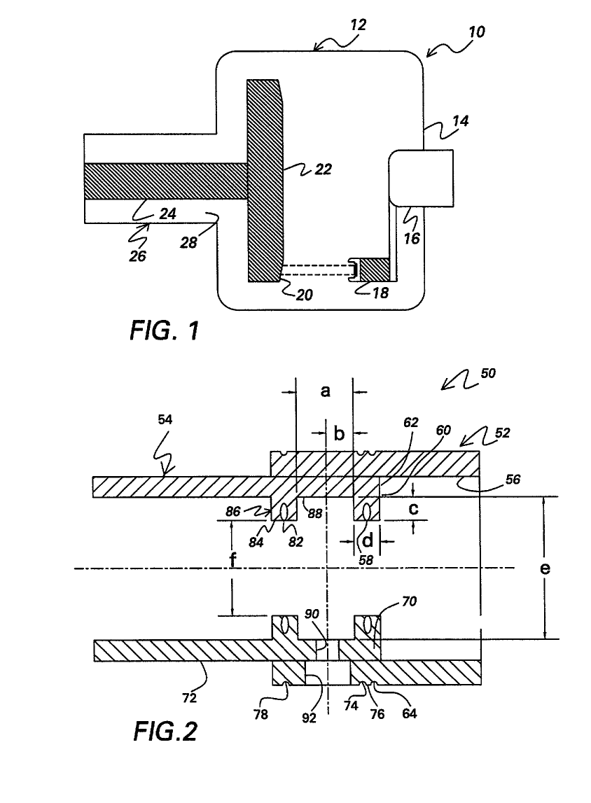

FIG. 1 is a schematic illustration of a typical x-ray source 10, sometimes referred to as an x-ray tube. Tube 10 includes a glass envelope 12 which at one end 14 has a cathode support 16 sealed into it. The electron emissive filament of a cathode is mounted on insulators located in a focusing cup 18 which focuses an electron beam against a beveled annular focal track area 20 of a rotating x-ray target 22. Target 22 is supported on a rotor shaft 24 that extends from a bearing housing and rotor assembly 26.

During operation, a rotating magnetic field induced in the motor rotor causes rotor shaft 24 to rotate. In addition, an electron beam is emitted from cathode cup 18 and is focused on beveled annular focal track area 20 of x-ray target 22. The electrons of beam collide with anode 22 and as a result, x-ray beams are generated. A focal spot is formed on the anode surface by the electron beam, and the x-ray beams emanate from the focal spot. The x-ray beams pass through a window in glass envelope 12 and pass through an object being imaged, such as a patient.

Rotor shaft 24 rotates on bearings contained within a bearing housing 28. If the bearings deteriorate, then shaft 24 may rotate at a speed slower than an expected speed. Such deterioration also may result in undesired movement, or wobbling, of target anode 22. Bearing deterioration therefore can adversely impact the characteristics of the x-ray beam emitted from x-ray source 10.

Bearing deterioration can be caused, for example, by failure to dissipate heat generated as rotor shaft 24 rotates on the bearings. To facilitate such heat dissipation, an oil cooling path typically is provided within bearing housing 28 so that oil flows axially relative to shaft 24. Heat is transferred to, and dissipated by, the axially flowing oil. While such axial flow paths have generally provided acceptable results, it would be beneficial to further enhance bearing cooling to extend bearing life.

FIG. 2 is a cross-sectional side view of a portion of an exemplary embodiment of a bearing housing 50. Bearing housing 50 is generally cylindrical and includes a first bearing containment section 52 and a second pool containment section 54. First bearing containment section 52 includes a bearing outer race surface 56 and a sealing cavity 58 located at an end 60 of a flange 62. Sealing cavity 58, as described below in more detail, captures incidental leakage of coolant from a coolant pool as described below in more detail. Cavity 58, in the exemplary embodiment, is 2 mm×2 mm. First bearing containment section 52 also includes an annular weld preparation groove 64 in an outer surface 66.

Second pool containment section 54 includes an end section 70 that mates with first containment section flange 62. Second section 54 also includes, in an outer surface 72, a first annular weld preparation groove 74 near an end 76 and a second annular weld preparation groove 78 spaced from first groove 74.

When end section 70 is mated with first containment section flange 62 as shown in FIG. 2 and as described in more detail below, first and second sections 52 and 54 are welded together to form bearing housing 50. Weld preparation grooves 64, 74 and 78 facilitate forming a reliable weld. A rotor bore 80 extends through housing 50 and is sized to receive a rotor shaft coupled at one end to a motor and at its other end to a target anode.

Second section 54 also includes a sealing cavity 82 located at an end 84 of a flange 86. Cavity 82, in the exemplary embodiment, is 2 mm×2 mm. A cooling medium containment wall 88 is radially outward relative to second section sealing cavity 82. More specifically, first section cavity 58 and second section cavity 82 define perimeters of a cooling medium pool. In addition, containment wall 88 defines a radially outermost perimeter of the cooling medium pool. As described in more detail below, first section cavity 58 and second section cavity 82 cooperate with annular flanges on a rotor shaft to facilitate preventing leakage of coolant from the pool.

Second section 54 further includes an opening 90 for facilitating the injection of a cooling medium into the cooling pool. A counter-bore 92 adjacent opening 90 is provided to facilitate securing a plug within opening 90 to prevent the leakage of coolant from the pool. The plug is removable so that additional coolant can be placed in the pool.

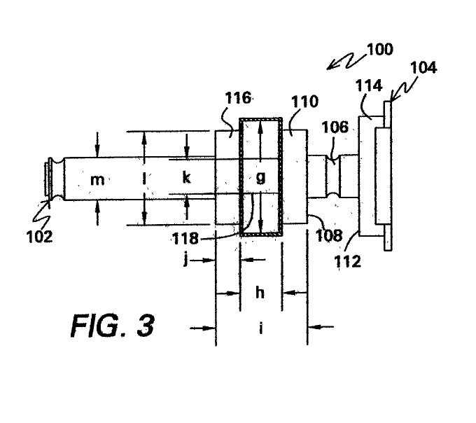

Referring to FIG. 3, which is a side view of an exemplary rotor shaft 100, shaft 100 is sized to be inserted within rotor bore 80 of housing 50. One end 102 of rotor shaft 100 is configured to be coupled to a motor, i.e., a motor coupling, and another end 104 of rotor shaft 100 is configured to be coupled to a target anode, i.e., a target anode coupling. The specific configuration of ends 102 and 104 is dictated by the coupling arrangements utilized for the motor and the target anode.

Shaft 100 also includes an inner race 106. A wall 108 of flange 110 and a wall 112 of target anode coupling 114 contain bearings within race 106. As explained above, housing 50 includes outer race 56, and multiple bearings are trapped between outer race 56 and inner race 106 when rotor shaft 100 and bearing housing 50 are assembled.

Rotor shaft 100 further includes annular flange 116, spaced from flange 110 with a radially inward containment wall 118 extending therebetween. Each flange 110 and 116 aligns with one of cavities 58 and 82, and together with one of respective cavities 58 and 82, forms a barrier to prevent cooling medium from leaking out of the pool.

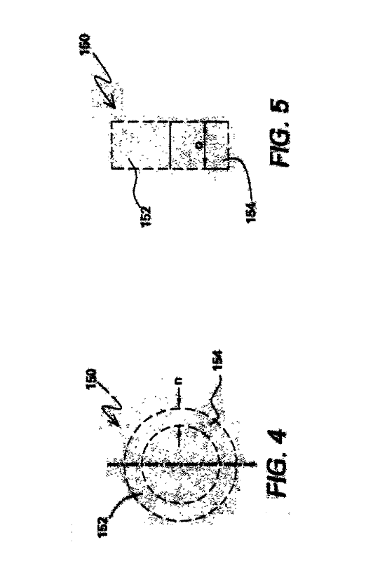

FIG. 4 is a front view of a rotor collar 150, and FIG. 5 is a side view of collar 150. Collar 150 includes a first section 152 and a second section 154, and is sized to fit between first and second flanges 110 and 116 of rotor shaft 100. Collar 150 facilitates maintaining a cooling medium within the coolant pool.

To assemble rotor shaft 100 and bearing housing assembly 50, first section 52 of bearing housing 50 is pushed over shaft 100 so that outer race 56 is positioned over inner race 106, and so that first section cavity 58 is aligned with flange 110. Ball bearings are located within, and trapped in the space between outer race 56 and inner race 106.

First and second sections 152 and 154 of rotor collar 150 are then located in the space between first and second flanges 110 and 116, and rotor collar sections 152 and 154 are fastened together, such as by tack welding. Second housing section 54 is then pushed over shaft 100 so that end section 70 mates with first containment section flange 62. Cavity 82 also is aligned with flange 116. First and second sections 52 and 54 are then also fastened together, such as by welding.

End 102 of rotor shaft 100 is coupled to a motor and rotor shaft end 104 is coupled to a target anode. A cooling medium is then injected into the pool via opening 90. Exemplary cooling mediums include liquid metal (e.g., gallium indium tin) and oil. Once the pool is full, a plug is then inserted into opening 90 to prevent leakage.

Bearing housing 50 and shaft 100 are fabricated from, for example, hardened steel (e.g., Rockwell 60 62 hardened). By way of example and not limitation, and with respect to the specific embodiment illustrated in FIGS. 2, 3, and 4, the following dimensions (in mm) correspond to the dimensions indicated by corresponding letters in the figures.

a 9.2+/−0.001

b 4.6

c 4.69

d 4.9

e 31.98+/−0.01

f 22.6+/−0.1

g 28.6

h 9

i 18

j 4.5

k 18.0

l 22.50+/−0.003

m 20.04 min

n 5.3

o 9.0

During operation, rotor shaft 100 rotates relative to housing 50. The bearings support shaft 100 and facilitate such relative rotation. Heat generated by the bearings is transferred to the walls of housing 50 and shaft 100. Because the cooling medium is in flow communication with shaft 100, the cooling medium dissipates heat from shaft 100. In addition, the cooling medium is displaced within and towards the walls of the containment pool by the centrifugal forces generated by rotating shaft 100. The cooling medium therefore is forced against the walls of the containment, which facilitate heat transfer from the walls to the cooling medium.

The above described bearing housing and rotor assembly facilitates dissipating heat generated by the rotor bearings. As explained above, improving heat dissipation can lead to extended bearing life as well as consistent operation of the x-ray source.

While the invention has been described in terms of various specific embodiments, those skilled in the art will recognize that the invention can be practiced with modification within the spirit and scope of the claims.

1. An x-ray source, comprising:
a target anode;
a rotor shaft coupled to said target anode;
a motor coupled to said rotor shaft at an end of said shaft opposite said target anode; and
a bearing housing comprising a rotor bore, said rotor shaft extending through said rotor bore and supported therein by a plurality bearings, said housing and said shaft forming a cooling medium pool so that as said shaft rotates, a cooling medium in said pool is radially displaced.

2. An x-ray source according to claim 1 wherein said bearing housing is generally cylindrical and comprises a first bearing containment section and a second pool containment section, said first bearing containment section comprising a bearing outer race surface and a sealing cavity located at an end of a flange.

3. An x-ray source according to claim 2 wherein said second pool containment section comprises an end section that mates with said first containment section, a sealing cavity, and a cooling medium containment wall radially outward relative to said second section sealing cavity.

4. An x-ray source according to claim 3 wherein said first section cavity and said second section cavity define perimeters of said cooling pool, and said containment wall defines a radially outermost perimeter of cooling medium pool.

5. An x-ray source according to claim 1 wherein said rotor shaft comprises an inner race, and said housing comprises an outer race, and a plurality of bearings are trapped between said outer race and said inner race.

6. An x-ray source according to claim 1 wherein said rotor shaft comprises spaced annular flanges and a radially inward containment wall extending therebetween.

7. An x-ray source according to claim 6 further comprising a rotor collar sized to fit between said spaced annular flanges.

8. A method for assembling a rotor shaft and a bearing housing, the bearing housing having a rotor bore therethough and comprising a first section and a section, said method comprising the steps of:
locating the first bearing housing section so that the rotor shaft extends therethrough and so that an outer race of the first bearing housing section aligns with an inner race of the rotor shaft;
locating the second bearing housing section so that the rotor shaft extends therethrough and so that an end section of the second section mates with the first section; and
welding the first section to the second section.

9. A method according to claim 8 further comprising the step of locating ball bearings in the space between the outer race and the inner race.

10. A method according to claim 8 further comprising the step of locating a rotor collar between spaced flanges of the rotor shaft.

11. A method according to claim 8 further comprising the step of injecting oil into a space between the bearing housing and the rotor shaft.

12. An x-ray source comprising:
means for generating an electron beam,
means for generating x-ray beams when said electron beam impinge thereon,
a rotor shaft coupled to said target anode; and
means for supporting said rotor shaft, said supporting means and said shaft forming a cooling medium pool so that as said shaft rotates, a cooling medium in said pool is radially displaced.

13. An x-ray source according to claim 12 wherein said supporting means comprises a first bearing containment section and a second pool containment section, said first bearing containment section comprising a bearing outer race surface and a sealing cavity located at an end of a flange, said second pool containment section comprises an end section that mates with said first containment section, a sealing cavity, and a cooling medium containment wall radially outward relative to said second section sealing cavity.

14. An x-ray source according to claim 12 wherein said rotor shaft comprises an inner race, and said supporting means comprises an outer race, and a plurality of bearings are trapped between said outer race and said inner race.

15. An x-ray source according to claim 12 wherein said rotor shaft comprises spaced annular flanges and a radially inward containment wall extending therebetween.

16. A bearing housing and rotor assembly, comprising:
a rotor shaft; and
a bearing housing comprising a rotor bore, said rotor shaft extending through said rotor bore and supported therein by a plurality bearings, said housing and said shaft forming a cooling medium pool so that as said shaft rotates, a cooling medium in said pool is radially displaced.

17. An assembly according to claim 16 wherein said bearing housing is generally cylindrical and comprises a first bearing containment section and a second pool containment section, said first bearing containment section comprising a bearing outer race surface and a sealing cavity located at an end of a flange.

18. An assembly according to claim 17 wherein said second pool containment section comprises an end section that mates with said first containment section, a sealing cavity, and a cooling medium containment wall radially outward relative to said second section sealing cavity.

19. An assembly according to claim 18 wherein said first section cavity and said second section cavity define perimeters of said cooling pool, and said containment wall defines a radially outermost perimeter of cooling medium pool.

20. An assembly according to claim 16 wherein said rotor shaft comprises an inner race, and said housing comprises an outer race, and a plurality of bearings are trapped between said outer race and said inner race.

21. An assembly according to claim 16 wherein said rotor shaft comprises spaced annular flanges and a radially inward containment wall extending therebetween.
